(19) United States
(12) Patent Application Publication
(10) Pub. No.: US 2026/0225719 A1
(43) Pub. Date: Aug. 6, 2026

(54) ICE PROTECTION DEVICE

(71) Applicant: Pegasus Research & Development GmbH, Köflach (AT)

(72) Inventors: Reinhard Puffing, Köflach (AT); Manuel Gerstenbrand, Voitsberg (AT); David Kozomara, Graz (AT)

(21) Appl. No.: 19/131,738

(22) PCT Filed: Nov. 21, 2023
(86) PCT No.: PCT/AT2023/060403

§ 371 Date: May 21, 2025

(30) Foreign Application Priority Data
Nov. 22, 2022 (AT) A 50883/2022
May 11, 2023 (WO) PCT/AT2023/060155

(51) Int. Cl. B64D 15/10; B64U 20/00

(52) U.S. Cl. CPC B64D 15/10; B64U 20/00

(57) ABSTRACT

The invention relates to an ice protection device (1) for aircraft (2), in particular unmanned aircraft (2), wherein the ice protection device (1) has at least one tank (7) for storing at least one deicing fluid and at least one nozzle (5), which is fluidically connected to the tank (7), for atomising the deicing fluid to droplets and applying same to at least part of the outer surface of the aircraft (2), characterised in that the ice protection device (1) is designed to produce droplets of deicing fluid having an average volume diameter of 300 μm or less.

The invention relates to an ice protection device for aircraft, in particular unmanned aircraft, wherein the ice protection device comprises at least one tank for storing at least one deicing fluid and at least one nozzle flow-connected to the tank for atomizing the deicing fluid into droplets and applying the same to at least part of the outer surface of the aircraft.

It also relates to an aircraft, preferably an unmanned aircraft, having such an ice protection device.

It further relates to a method for deicing an aircraft, preferably an unmanned aircraft, wherein at least one deicing fluid is fed from a tank to a nozzle, wherein the nozzle atomizes the deicing fluid into droplets and the droplets are applied to at least part of the outer surface of the aircraft.

The method is preferably carried out during the flight of the aircraft.

Ice protection devices and methods are used to reduce or completely dissolve icing on the outer surface of an aircraft. For this purpose, the deicing fluid, usually a homogeneous liquid, is atomized and applied to the area of the outer surface, where it adheres to the icing and the outer surface and dissolves existing icing. This can also be done as a precautionary measure before icing occurs in order to prevent or delay it.

The limited storage capacity of deicing fluid is a major problem, particularly with fluid-based ice protection devices for aircraft. On the one hand, there is only limited space available in the aircraft and, on the other hand, the aircraft should be as light as possible and the ice protection device should add as little additional weight as possible.

Another problem with aircraft is that deicing sometimes takes place during normal flight and therefore the aircraft moves at high speed while the deicing fluid is being applied. Even if the fastest possible deicing and thus the highest possible speed of movement of the nozzles along the surface to be deiced is to be achieved with ground vehicles for deicing, the speeds in comparison to the full flight speed of aircraft, which can be in the range of 50 km/h to 70 km/h even with smaller drones, and 300 km/h or even higher in certain embodiments, are considerably lower.

U.S. Pat. No. 5,911,363 A describes a ground vehicle having an ice protection device. The ice protection device is designed to deice as large an area as possible at the highest possible speed. Accordingly, enormous quantities of deicing fluid are consumed, which is not a problem with ground vehicles due to the larger tanks and the ease of refilling.

U.S. Pat. No. 5,104,068 A discloses a stationary ground ice protection device that discloses nozzles with a diameter in the range of over 5 mm. Here, too, a large amount of fluid is consumed in order to achieve rapid deicing.

An ice protection device for a wind turbine is known from EP 1 496 251A1, which has several perforations from which large quantities of fluid slowly escape onto the rotor blades. Atomization does not take place. Something similar is also known from U.S. Pat. No. 3,423,052 A, which discloses a fluid-absorbing, porous layer that distributes the fluid over the wings of an aircraft. Here too, no atomization is achieved, but distribution takes place via the porous layer.

US 2013/0267375 A1 describes a wind turbine that has various nozzles, some of which are used for deicing.

Accordingly, it is the object of the present invention to enable the most complete and fastest possible deicing with the lowest possible consumption of deicing fluid, even at high movement speeds of the aircraft.

This object is solved in accordance with the invention in that the ice protection device is designed to produce droplets of deicing fluid having a volume mean diameter of 300 μm or less. Preferably, the ice protection device is designed to produce droplets of deicing fluid with a volume mean diameter of between 10 μm and 150 μm and/or between 5 μm and 100 μm and/or between 40 μm and 110 μm. It is also solved in that the droplets of deicing fluid have a volume mean diameter of 300 μm or less. It is preferably provided that the droplets of deicing fluid have a volume mean diameter of between 10 μm and 150 μm and/or between 5 μm and 100 μm and/or between 40 μm and 110 μm.

Preferably, the droplets have the specified volume mean diameters at 23° C. and/or at −5° C. and/or at −10° C. outside temperature.

Preferably, the droplets have the specified volume mean diameters at a deicing fluid temperature of 23° C. and/or −5° C. and/or −10° C.

It has been shown that by providing droplets of the specified size distribution, surprisingly a particularly good surface application of the deicing fluid is achieved, even if the airspeed is high. It is particularly advantageous that only small amounts of fluid are sufficient to achieve adequate deicing, as a sufficiently large droplet cloud can be formed and the droplets can settle particularly well on the surface. The droplet size can be achieved by adjusting the temperature, nozzle diameter, viscosity and/or pressure of the deicing fluid and/or depending on the outside temperature. Particularly good application has been shown when the ice protection device is designed to produce droplets of deicing fluid with a volume mean diameter of 125 μm or less or when the droplets of deicing fluid have a volume mean diameter of 125 μm or less.

Preferably, the deicing fluid has a dynamic viscosity of less than 15 mPa*s, particularly preferably less than 12 mPa*s, most preferably less than 8 mPa*s or most preferably less than 6 mPa*s at 23° C.

Preferably, the deicing fluid has a dynamic viscosity of less than 70 mPa*s, particularly preferably less than 65 mPa*s, most preferably less than 25 mPa*s or most preferably less than 20 mPa*s at −10° C.

Preferably, the deicing fluid has a dynamic viscosity of less than 130 mPa*s, particularly preferably less than 40 mPa*s, most preferably less than 33 mPa*s or most preferably less than 20 mPa*s at −20° C.

Preferably, the deicing fluid has a kinematic viscosity of less than 15 mm²/s, particularly preferably less than 12 mm²/s, most preferably less than 8 mm²/s or most preferably less than 6 mm²/s at 23° C.

Preferably, the deicing fluid has a kinematic viscosity of less than 70 mm²/s, particularly preferably less than 65 mm²/s, most preferably less than 25 mm²/s or most preferably less than 20 mm²/s at −10° C.

Preferably, the deicing fluid has a kinematic viscosity of less than 120 mm²/s, particularly preferably less than 40 mm²/s, most preferably less than 32 mm²/s or most preferably less than 20 mm²/s at −20° C.

Low viscosities are particularly advantageous, as the pressure required to atomize and distribute the deicing fluid and thus also the energy requirement and system weight are reduced.

Preferably, the deicing fluid has a surface tension of less than 60 mN/m, particularly preferably less than 45 mN/m and most preferably less than 35 mN/m at 23° C and/or at −10° C.

Preferably, the deicing fluid has a density of less than 1.3 g/cm³, particularly preferably less than 1.2 g/cm³ and most preferably less than 1.15 g/cm³ or most preferably less than 1.1 g/cm³ at 23° C. and/or at −10° C.

The outer surface refers to one or more surfaces of the aircraft that come into contact with the environment, i.e. are directed outwards. This can be, for example, a part of the housing, wings, antennas, sensors, cameras, goods to be transported, propellers or even the rotor blades or the engines.

The volume mean diameter, also known as D30 or “volume mean diameter”, is the diameter of a droplet whose volume multiplied by the total number of droplets in a droplet quantity results in the total volume of all droplets in the droplet quantity. In other words, this volume mean diameter represents the diameter of the droplet whose volume has the mean volume of all droplets in a droplet quantity.

The nozzle is preferably an atomizing nozzle. It may be provided that the atomization shape of the nozzle is a solid cone or a hollow cone. The atomization shape may also depend on the area of the aircraft on which the deicing fluid is to be applied and/or on the area of the aircraft in which the nozzle is arranged. For example, it may be advantageous if at least one nozzle is arranged in the area of at least one rotor and/or one engine and/or is directed towards these and/or is intended to apply deicing fluid to at least one rotor and/or engine.

It may be provided that at least one nozzle is heated. Accordingly, it may be provided that at least one nozzle has a heating device. It may be provided that, for atomizing and/or distributing the deicing fluid, the deicing fluid is mixed with at least one other fluid such as the ambient air, another gas or another liquid, preferably through the nozzle or in the area of the nozzle. It may also be provided that the deicing fluid consists of multiple components, preferably stored separately, which are only mixed through the nozzle.

Preferably, it is provided that when the pressure of the deicing fluid falls below a pressure threshold value, the flow of the deicing fluid for atomization in the nozzle is interrupted. Preferably, the interruption takes place inside the nozzle or directly in front of the nozzle. In this sense, it may also be provided that at least one pressure switching valve is provided between the tank and at least one nozzle and/or in the nozzle. Pressure switching valves are designed to shut off a flow until a set pressure threshold value is reached. Preferably, the pressure threshold value is selected to be one, two or three bar below the operating pressure during a spraying process. This ensures that the pressure in the lines does not drop too much during a break between spraying processes and saves time and energy for restoring the operating pressure.

It may be provided, in particular with regard to the explanations in the last paragraph, that at least one nozzle is a two-substance nozzle. It may also be provided that at least one nozzle is a single-substance nozzle.

It may be provided that the ice protection device has at least one temperature control device for the deicing fluid and that the temperature control device is preferably designed to adjust the deicing fluid supplied to the nozzle to a temperature of at least −5° C., particularly preferably at least 1° C. This is particularly important at especially low outside temperatures, for example below −40° C., as otherwise components of the fluid may flocculate. It is particularly preferably provided that the temperature control device is designed to use the waste heat and/or residual heat from another part of the aircraft, for example at least one engine or at least one power unit, for this purpose. This can be achieved, for example, by the tank or the supply line connecting the tank to the nozzle having at least one heat transfer unit for introducing waste heat and/or residual heat from another part of the aircraft. This heat transfer unit can, for example, be a jacket surface of the tank or channels arranged in the tank, for example filled with heat transfer fluid, which transfer the heat from the other part. Alternatively or additionally, it may be provided that the deicing fluid can be tempered before or during the flight, preferably to a temperature of at least −5° C., particularly preferably at least 1° C. This results in a low viscosity and thus improves atomization into droplets. Due to the good storage of heat, temperature control before take-off may be sufficient. The temperature control device can be an independent unit of the ice protection device, but it can be represented in whole or in part by another element of the ice protection device. For example, a pump and/or a compressor for transporting and/or compressing the deicing fluid in the direction of the nozzle or nozzles can be set up to temper the deicing fluid. The pump or compressor thus acts as a temperature control device. Temperature control means cooling, heating and/or adjusting the deicing fluid to a specific temperature.

Preferably, it is provided that the ice protection device is designed to generate droplets of which at least 50% have a diameter of less than 300 μm, preferably less than 200 μm, and most preferably less than 150 μm. This achieves an even better impact on the surface and thus enables more efficient deicing. The same also applies if it is intended that at least 50% of the droplets have a diameter of less than 300 μm, preferably less than 200 μm, and most preferably less than 150 μm.

It is particularly advantageous if the nozzle diameter of the nozzle is 0.5 mm or less, preferably 0.3 mm or less, particularly preferably 0.2 mm or less. The nozzle diameter of the nozzle is particularly preferably 0.15 mm or less. This enables a particularly simple and energy-efficient provision of the desired droplet size. Nozzles with a larger diameter result in a significantly higher consumption of deicing fluid, which is disadvantageous due to the resulting shorter range or increased tank requirement.

For controlled delivery of the deicing fluid to the nozzle, it may be provided that the ice protection device has at least one delivery device for delivering the deicing fluid to the nozzle, preferably with adjustable feed pressure. This allows the droplet size to be adjusted depending on other parameters such as the viscosity of the deicing fluid or one of its components, its temperature or the outside temperature, the degree of deicing or the current airspeed. The same also applies if the pressure of the deicing fluid that is fed to the nozzle is adjusted as a function of the ambient temperature and/or the temperature of the deicing fluid in such a way that droplets of deicing fluid have a volume mean diameter of 300 μm or less, preferably 125 μm or less.

Preferably, the deicing fluid is provided to the nozzles at a pressure below 30 bar, particularly preferably below 15 bar, most preferably between 4 bar and 20 bar or between 2 bar and 15 bar, most preferably below 16 bar or below 10 bar, most preferably between 6 bar and 12 bar or between 5 bar and 8 bar. It has been shown that this pressure is sufficiently high to generate the desired droplet size without having to use too much energy to provide the pressure. It may also be provided that a pressure above 30 bar or above 15 bar, for example below 20 bar, below 30 bar, below 40 bar or below 50 bar, is advantageous, particularly in the case of larger aircraft.

It is particularly advantageous if the deicing fluid contains glycol and is preferably based on glycol and/or that the deicing fluid contains ethanol and/or that the deicing fluid contains water. Such a deicing fluid in combination with the specified droplet size results in particularly good contact with the outer surface and therefore particularly efficient deicing. Especially in combination with the specified nozzle sizes, the droplet size can be provided in a particularly simple manner.

The use of water enables a lower viscosity and reduces flammability.

It is also possible for the deicing fluid to contain ethanol or another lower or medium-chain, preferably monohydric, alcohol, with or without glycol. Lower alcohol means an alcohol having one to five carbon atoms and medium alcohol means an alcohol having six to nine carbon atoms.

The glycol can preferably comprise or be monoethylene glycol; alternatively or additionally, the glycol can also comprise other glycols or be, for example methylene glycol, or longer glycols, but also glycol ethers such as diethylene glycol. Based on glycol means that the main active component of the deicing fluid is glycol.

Preferably, the deicing fluid comprises both glycol and a low or medium-chain alcohol, preferably ethanol. Particularly preferably, the deicing fluid also contains water. This is particularly advantageous because such deicing fluids have a low viscosity even at low temperatures, which means that the droplet size can be easily achieved. Furthermore, the addition of water can reduce or prevent flammability.

Preferably, the deicing fluid has a glycol content of at least 40% by volume and/or a maximum of 60% by volume.

Preferably, the deicing fluid has a proportion of low or medium-chain alcohol, preferably ethanol, of at least 30% by volume and/or a maximum of 45% by volume. The alcohol, in particular ethanol, has a positive effect on the atomization properties of the deicing fluid. A higher proportion of ethanol can be problematic due to its flammability.

Preferably, at least one filter unit for filtering the deicing fluid is provided between the tank and the nozzle along their connection. It may also be provided that the deicing fluid is filtered before being atomized by the nozzle. In this way, suspended particles can be filtered out and clogging or wear of the nozzle or influence on the droplet spectrum can be prevented.

It is particularly advantageous if the ice protection device is set up to detect deicing by means of at least one sensor and/or at least one measured value and to start atomization and application depending on the detection. In this way, deicing fluid can be saved. The sensor can include, for example, a capacitive surface sensor or optical sensors for arrangement on an outer surface of the aircraft or vibration probes. The measured values can relate to the operating states of the aircraft, for example the current power or fuel consumption of the rotors or engines and/or other flight parameters such as the airspeed or the outside temperature or the relative or absolute humidity of the environment. Accordingly, it may also be provided that deicing is detected via at least one sensor and/or at least one measured value of the aircraft and atomization is started depending on the detection.

It may also be provided that the amount of atomized deicing fluid is regulated depending on the sensor and/or the measured values.

It is also advantageous if at least one nozzle of the ice protection device is directed towards a rotor and/or engine of the aircraft and is preferably arranged along the air flow generated by the rotor and/or engine behind the rotor and/or engine. This enables particularly efficient deicing of the rotor and/or engine. Paradoxically, an arrangement of the nozzle behind the rotor and/or engine (in the case of an upward-pointing rotor or engine as under the rotor or engine) is particularly advantageous, so that the nozzle sprays against the air flow generated by the rotor and/or engine. However, it has been shown that this unintuitive arrangement also enables efficient deicing in addition to the structural advantages. This is because a particularly large amount of ice can accumulate on the rear or underside of the propeller blade in certain flight attitudes. Depending on the orientation of the rotor or engine, more ice may also accumulate on the rear or underside of the rotor or propeller blade. The same applies if it is provided that at least one nozzle sprays the droplets in the direction of a rotor and/or engine of the aircraft and is preferably arranged behind the rotor and/or engine along the air flow generated by the rotor and/or engine. Alternatively, it may be provided that the nozzle is arranged in front of the rotor and/or engine along the air flow generated by the rotor and/or engine.

The alignment of the nozzle in one direction means that the nozzle points at least partially in this direction, i.e. it is not aligned perpendicular to the direction or even points in the opposite direction.

An arrangement along the air flow generated by the rotor and/or engine downstream of the rotor and/or engine means that the nozzle is arranged downstream of the rotor and/or engine along the air flow and preferably also in the air flow.

Furthermore, it may be provided that the aircraft has a main flight direction, preferably defined by wings and/or other rigid air guiding elements, and that at least one nozzle of the ice protection device is directed in the direction of the main flight direction. This enables the droplets to be applied to a particularly large outer surface of the aircraft. The same also applies if at least one nozzle sprays the droplets in the direction of a main flight direction of the aircraft, preferably defined by wings and/or other rigid air guiding elements.

Furthermore, it may be provided that the aircraft has at least two rotors and/or engines which point essentially in the same direction and that at least one nozzle of the ice protection device points in the same direction and is preferably arranged between these rotors and/or engines. Pointing in one direction means the direction against which the air flow generated by the rotor and/or engine is directed. Such an arrangement can be particularly advantageous if the rotors and/or engines work essentially against the force of gravity. The same also applies if the aircraft has at least two rotors and/or engines which point in essentially the same direction and that the deicing fluid is sprayed in the same direction, and that preferably the deicing fluid is sprayed between these rotors and/or engines in this direction.

Pointing in the same direction means that the nozzle points at least partially in the same direction as the rotor, i.e. is not perpendicular to its direction or even turned away from it.

Furthermore, a method for deicing an aircraft, preferably an unmanned aircraft, can be particularly advantageous, in which at least one deicing fluid is fed from a tank to a nozzle, wherein the nozzle atomizes the deicing fluid into droplets during a spraying process and the droplets are applied to at least part of the outer surface of the aircraft, characterized in that several spraying operations are carried out in succession and pauses are made between the spraying operations in which no or substantially less atomization and application is carried out. This method and its further aspects can be provided on their own (i.e. without restriction to a specific volume mean diameter) or also in combination with the other embodiments described in this description. Accordingly, it may be provided that the deicing device has a control or regulating unit which is designed to control or regulate the supply of deicing fluid to the nozzle and is preferably set up to cyclically interrupt the supply of deicing fluid to the nozzle by means of pauses.

Such a method leads to a significant reduction in the amount of deicing fluid used, but can still effectively limit or completely prevent icing.

It may also be provided that the ratio between spraying operations and pauses or the respective absolute duration of the spraying operations and/or pauses is carried out by at least one sensor, preferably continuously, depending on the icing detected on the aircraft. Accordingly, it may also be provided that the control or regulating unit is set up to adjust the ratio between spraying operations and pauses or the respective absolute duration of the spraying operations and/or pauses as a function of the icing of the aircraft detected by at least one sensor, preferably continuously. Preferably, the determination of icing comprises the use of at least one of the following parameters: Rotational speed of the rotors, inertia of the aircraft, reaction time of the aircraft, and/or power demand of the engines. Preferably, an algorithm determines the absolute duration of the spraying processes and/or pauses depending on at least one of the parameters mentioned.

Furthermore, it is particularly advantageous if at least one spraying operation, preferably at least the majority of the spraying operations and most preferably at least 80% of the spraying operations take less than 20 seconds, preferably less than 15 seconds and most preferably less than 10 seconds. Surprisingly, it was found that such short spraying intervals are sufficient to achieve good deicing. The short spraying processes also save on deicing fluid.

Preferably, at least one nozzle is supplied with deicing fluid at least intermittently, preferably continuously, during the pause, particularly preferably with a hold-free quantity. This can prevent the nozzle itself from icing up. It is sufficient if it is supplied with a very small quantity of deicing fluid, i.e. with a release quantity of 10 ml/h, for example. In this sense, it may be provided that the nozzle is supplied with significantly lower pressure compared to the spraying processes. In this sense, it may be advantageous if the ice protection device is set up to supply at least one nozzle with deicing fluid during pauses between spraying processes, preferably with a hold-free quantity.

It may be provided, for example, that the spraying processes in a first operating mode last shorter than the pauses between them and, particularly preferably, that the pauses last at least twice as long and, most preferably, at least five times as long as the spraying processes. For example, it may be provided that the spraying processes last 10 seconds and the pauses 50 seconds, the spraying processes 5 seconds and the pauses 55 seconds or the spraying processes 3 seconds and the pauses 27 seconds.

Furthermore, it may be provided that the spraying processes in a second operating mode last longer than the spraying processes in the first operating mode, preferably that the spraying processes in the second operating mode last at least twice as long as the spraying processes in the first operating mode. It may be provided that the effect of the deicing is measured during the first operating mode with at least one sensor and that the system switches from the first to the second operating mode if the effect exceeds a certain limit value. For example, the energy consumption of the drive units of the aircraft can be monitored. If it is determined that deicing during the first operating mode leads to a significant reduction in the required energy, this is an indicator that deicing is taking place which is having a negative effect on the flight of the aircraft and that more deicing would be beneficial. The system therefore switches to the second operating mode and deicing is increased. In this way, the amount of deicing fluid used can be significantly reduced but, if necessary, deicing can still be carried out as completely as possible.

It may also be provided that in the second operating state, continuous deicing takes place via a spraying process, without pauses.

In the following, the invention is described with reference to non-limiting embodiments according to the invention in the figures, wherein:

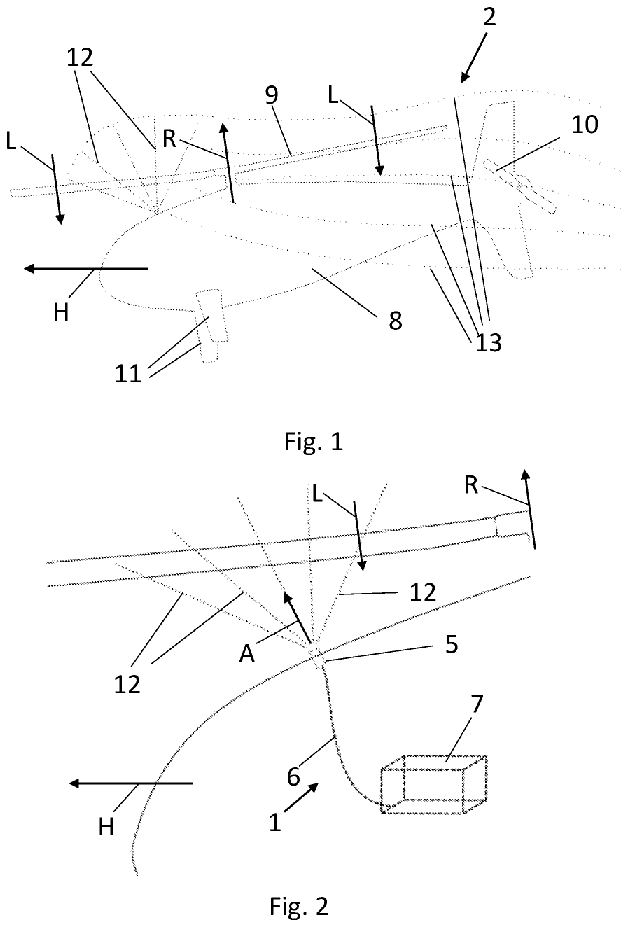

FIG. 1 shows a schematic representation of a first embodiment of an unmanned aerial vehicle according to the invention in a side view during flight and during deicing;

FIG. 2 shows a section from FIG. 1 for a better view;

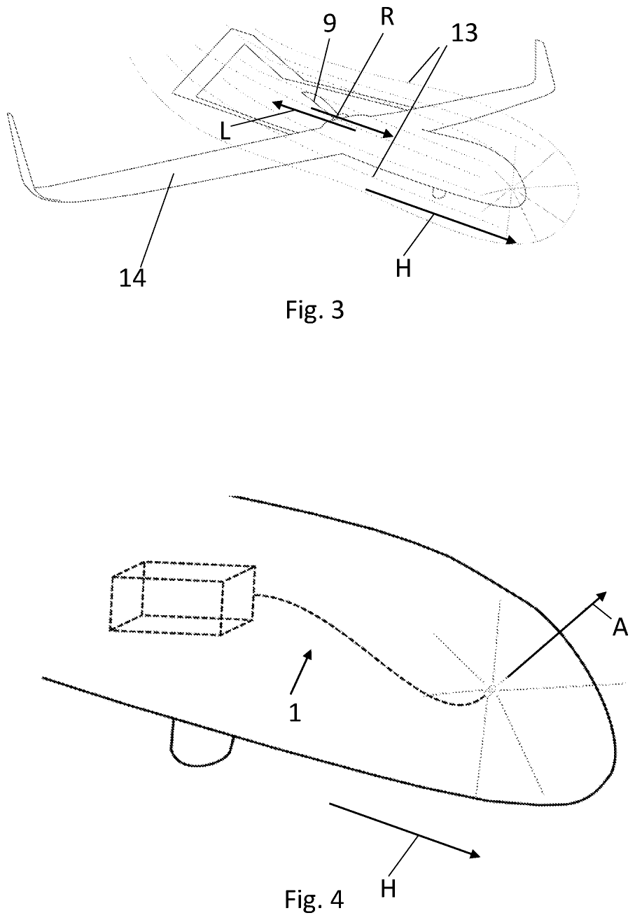

FIG. 3 shows a schematic representation of a second embodiment of an unmanned aerial vehicle according to the invention in a side view during flight and during deicing;

FIG. 4 shows a section from FIG. 3 for a better view;

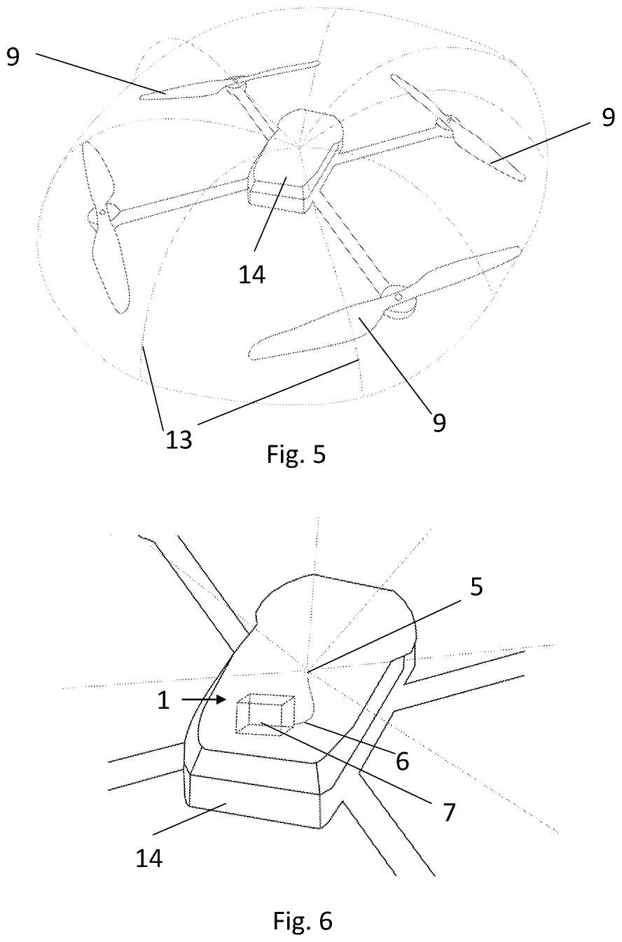

FIG. 5 shows a schematic representation of a third embodiment of an unmanned aerial vehicle according to the invention in a side view during flight and during deicing;

FIG. 6 shows a section from FIG. 5 for a better view.

FIG. 1 and FIG. 2 show a first embodiment of an unmanned aerial vehicle 2 that has an ice protection device 1 according to the invention. Since most of the components of the ice protection device 1 are located inside the aircraft 2, it is only shown in FIG. 2.

The ice protection device 2 has a tank 3 and a supply line 4, which connects the tank 3 to a nozzle 5 and supplies the nozzle 5 with the deicing fluid from the tank 3. A conveying device, not shown, is provided which adjusts the quantity and/or pressure and/or temperature of the deicing fluid that is fed to nozzle 5. Both the tank 3 and the supply line 4 are located inside the housing 8 of the aircraft 2, with only the nozzle 5 facing outwards.

The aircraft 2 has a rotor 9 and a tail rotor 10 and uses the same flight mode as a helicopter. The shape of its housing 8, the tail boom and the tail units 11 define a main flight direction H of the aircraft 2. The rotor 9 also generates an airflow L, which essentially acts against gravity. The rotor 9 is directed in the opposite direction R.

FIG. 2 clearly shows that the nozzle 5 points in the direction of the main flight direction H. Furthermore, it also points in the same direction as the rotor 9, which points in direction R. This can be seen from the alignment arrow A of nozzle 5, which is at an angle of less than 90° to both the direction R and the main flight direction H.

In this embodiment, the nozzle 5 is arranged behind the rotor 9 and also below the rotor 9. Below the rotor 9 means that the nozzle 5 is located along a plane normal to the direction R of the rotor 9 in the span of the rotor blades. This can also be advantageous in other embodiments.

The nozzle 5 sprays the deicing fluid atomized into droplets in a spray radius diagonally upwards, indicated by stripes 12. The flight along the main flight direction H results in a droplet cloud 13, which envelops and thus deices a substantial part of the outer surface of the aircraft 2.

FIG. 3 and FIG. 4 show a second embodiment that is very similar to the first embodiment, so only the most significant differences are discussed here. Features with the same effect have the same reference sign.

The aircraft 2 now has a different structure and has wings 14 and a single rotor 9, which is aligned in the direction of the main direction of movement H. In this embodiment, the nozzle 5 is also aligned in the direction of the main direction of movement H and also like the rotor (direction R), see alignment arrow A.

The nozzle 5 is arranged centrally along the width of the aircraft 2. The droplet cloud 13 thus essentially envelops the entire fuselage of the aircraft 2 and also the rotor 9.

In this embodiment, the nozzle 5 is arranged in front of the rotor 9.

FIG. 5 and FIG. 6 show a third embodiment that is very similar to the first and second embodiments, so only the most significant differences are discussed here. Identical features have the same reference sign.

This unmanned drone has four rotors 9, which all point in the same direction R. They are arranged symmetrically around a fuselage 14, in which the ice protection device 1 is arranged. A nozzle 5 points in the same direction R (see alignment arrow A) and is arranged between the rotors 9.

Preferably, the nozzle 5 is arranged centrally between the rotors 9. During operation of the ice protection device 1, it produces a cloud of droplets 13 that essentially envelops the entire aircraft 2.

In this embodiment, the nozzle 5 is arranged in front of the rotors 9.

1. An ice protection device for aircraft, in particular unmanned aircraft, comprising: at least one tank for storing at least one deicing fluid; and
at least one nozzle flow-connected to the tank for atomizing the deicing fluid into droplets and applying the same to at least part of the outer surface of the aircraft, wherein the ice protection device is designed to produce droplets of deicing fluid having a volume mean diameter of 300 μm or less.

2. The ice protection device according to claim 1, wherein the ice protection device is configured to produce droplets of which at least 50% have a diameter of less than 300 μm.

3. The ice protection device according to claim 1, wherein the nozzle diameter of the nozzle is 0.5 mm or less.

4. The ice protection device according to claim 1, wherein the ice protection device has at least one conveying device for conveying the deicing fluid to the nozzle with adjustable feed pressure.

5. The ice protection device according to claim 1, wherein the deicing fluid contains glycol.

6. The ice protection device according to claim 1, wherein the ice protection device is set up to detect deicing by means of at least one sensor or at least one measured value and to start atomization and application depending on the detection.

7. An aircraft, wherein the aircraft comprises an ice protection device according to claim 1.

8. The aircraft according to claim 7, wherein at least one nozzle of the ice protection device is directed in the direction of a rotor or engine of the aircraft and is preferably arranged behind the rotor or engine along the air flow generated by the rotor or engine.

9. The aircraft according to claim 7, wherein the aircraft has a main flight direction defined by wings or other rigid air guiding elements, and at least one nozzle of the ice protection device is directed in the direction of the main flight direction.

10. The aircraft according to claim 7, wherein the aircraft has at least two rotors or engines, which point in the same direction, and at least one nozzle of the ice protection device points in the same direction and is arranged between the rotors or engines.

11. An ice protection device for aircraft, in particular unmanned aircraft, comprising: at least one tank for storing at least one deicing fluid and at least one nozzle which is flow-connected to the tank for atomizing the deicing fluid into droplets and applying the same to at least part of the outer surface of the aircraft, wherein the deicing device has a control or regulating unit which is configured to control or regulate the supply of deicing fluid to the nozzle and is set up to cyclically interrupt the supply of deicing fluid to the nozzle by means of pauses.

12. The ice protection device according to claim 11, wherein the control or regulating unit is set up to adjust the ratio between spraying operations and pauses or the respective absolute duration of the spraying operations or pauses as a function of the icing of the aircraft detected by means of at least one sensor.

13. (canceled)

14. A method for deicing an aircraft, wherein at least one deicing fluid is fed from a tank to a nozzle, wherein the nozzle atomizes the deicing fluid into droplets and the droplets are applied to at least a part of the outer surface of the aircraft, wherein the droplets of deicing fluid have a volume mean diameter of 300 μm or less.

15. The method according to claim 14, wherein at least 50% of the droplets have a diameter of less than 300 μm.

16. The method according to claim 14, wherein the pressure of the deicing fluid supplied to the nozzle is adjusted as a function of the ambient temperature or the temperature of the deicing fluid in such a way that droplets of deicing fluid have a volume mean diameter of 300 μm or less.

17. The method according to one of claims 14 t, wherein at least one nozzle sprays the droplets in the direction of a rotor or engine of the aircraft and is preferably arranged behind the rotor or engine along the air flow generated by the rotor or engine.

18. The method according to claim 14, wherein at least one nozzle sprays the droplets in the direction of a main flight direction of the aircraft, defined by wings and/or other rigid air guiding elements (11, 14).

19. The method according to claim 14, wherein the aircraft has at least two rotors or engines which point in the same direction and in that the deicing fluid is sprayed in the same direction, and the deicing fluid is sprayed between these rotors or engines in this direction.

20. A method for deicing an aircraft, comprising:
at least one deicing fluid is fed from a tank to a nozzle, wherein the nozzle atomizes the deicing fluid into droplets during a spraying operation and the droplets are applied to at least part of the outer surface of the aircraft, wherein several spraying operations are carried out in succession and pauses are made between the spraying operations in which no or substantially less atomization and application is carried out.

21. The method according to claim 20, wherein the ratio between spraying operations and pauses or the respective absolute duration of the spraying operations or pauses is carried out by at least one sensor, depending on the icing detected on the aircraft.

22. The method according to claim 20, wherein at least one spraying operation, take less than 20 seconds,

23. (canceled)
